(19) United States
(12) Patent Application Publication
(10) Pub. No.: US 2017/0278110 A1
(43) Pub. Date: Sep. 28, 2017

(54) REINFORCEMENT ALLOCATION IN SOCIALLY CONNECTED PROFESSIONAL NETWORKS

(71) Applicant: International Business Machines Corporation, Armonk, NY (US)

(72) Inventors: RAPHAEL EZRY, New York, NY (US); Munish Goyal, Yorktown Heights, NY (US); Leonard G. Polhemus, JR., Wappingers Falls, NY (US); Jingzi Tan, Chicago, IL (US); Shobhit Varshney, Somers, NY (US)

(73) Assignee: International Business Machines Corporation, Armonk, NY (US)

(21) Appl. No.: 15/081,979

(22) Filed: Mar. 28, 2016

(51) Int. Cl. G06Q 30/02; G06F 19/00; G06F 17/30

(52) U.S. Cl. CPC G06Q 30/0201; G06F 17/30867; G06Q 30/0282; G06F 19/326; G06Q 50/01

(57) ABSTRACT

A network of nodes is constructed from data obtained from a data source of a social medium. A node corresponds to a medical professional. From the data, a likelihood is determined of the node prescribing a product. From the data, for a period, a level of knowledge is computed of the node about the product. A change in the level of knowledge of the node from a previous period is determined. Using a change in a level of knowledge corresponding to each node in the network, an amount of knowledge reinforcement to be applied to each node in the network is computed. A knowledge reinforcement resource to perform knowledge reinforcement at a subset of the nodes is allocated according to a schedule, where the allocated knowledge reinforcement resource to the node has a correspondence with the change in the level of knowledge of the node.

### TECHNICAL FIELD

The present invention relates generally to a method, system, and computer program product for budgeting and scheduling knowledge reinforcement efforts directed at socially networked medical professionals. More particularly, the present invention relates to a method, system, and computer program product for reinforcement allocation in socially connected professional networks.

### BACKGROUND

Physicians, doctors, and other persons who are qualified to practice in the medical field and prescribe pharmaceutical drugs are collectively and interchangeably referred to herein as medical professionals, or simply professionals, in singular or plural as applicable, unless expressly distinguished where used.

Detailing to medical professionals has been the primary promotion vehicle for pharmaceutical companies. Detailing is the process of providing knowledge about a pharmaceutical drug to a medical professional with the expectation that the professional will prefer or choose to prescribe the drug over another competing pharmaceutical drug where either drug is applicable for a patient. Such provision of knowledge is referred to herein as knowledge reinforcement, or simply reinforcement.

Knowledge reinforcement can be scheduled any number of times for the same drug with the same professional. In a scheduled knowledge reinforcement, a pharmaceutical sales representative travels to the professional's office, announces himself to the office receptionist or to the nurse at a hospital, and waits to see a professional to make his sales presentation. If the professional has time between seeing patients and other professional duties, the professional meets with the sales representative, and the sales representative provides the professional with knowledge about a pharmaceutical drug, promotional information, and drug samples, with an aim to influence the professional's treatment decision in favor of that drug.

Pharmaceutical companies devote a considerable amount of time to determining the effectiveness of their reinforcement activities. Reinforcement activities cost time and money, and are therefore budgeted for a period of time. In many cases, a reinforcement activity is scheduled several times for the same drug with the same professional, incurring time and money costs at each occurrence.

Social media—also interchangeably referred to as social network—comprises any medium, network, channel, or technology for facilitating communication between a large number of individuals and/or entities (users). Social media allow users to interact with one another individually, in a group, according to common interests, casually or in response to an event or occurrence, and generally for any reason or no reason at all.

Certain social media or social networks are specifically adapted for use by medical professionals. Some non-limiting examples of such specialized social media include Doximity and SERMO (Doximity and SERMO are each trademarks of their respective owners.)

Some other examples of such specialized social media are websites or data sources associated with news channels, magazines, publications, blogs, and sources or disseminators of news or information about the pharmaceutical industry. Some more examples of such specialized social media are websites or repositories associated with the pharmaceutical interest groups, action groups, committees, organizations, teams, or other associations of medical professionals.

Data from social media, including but not limited to the social media configured for use by professionals, comprises unidirectional messages, or bi-directional or broadcast communications in a variety of languages and forms. Such communications in the social media data can include proprietary conversational styles, slangs or acronyms, urban phrases in a given context, formalized writing or publication, and other structured or unstructured data.

A professional's contributions or interactions with the specialized social media can include any type or size of data. For example, a professional can post text, pictures, videos, links, or combinations of these and other forms of information to a specialized social media website. Furthermore, such information can be posted in any order, at any time, for any reason, and with or without any context.

### SUMMARY

The illustrative embodiments provide a method, system, and computer program product. An embodiment includes a method that constructs, from data obtained from a data source of a social medium, a network including a node, the node corresponding to a medical professional, and the network including a plurality of other nodes corresponding to other participants connected with the medical professional in the social medium. The embodiment determines, from the data, a likelihood of the node prescribing a product. The embodiment computes, using a processor and a memory, from the data, for a period, a level of knowledge of the node about the product. The embodiment determines a change in the level of knowledge of the node from a previous period. The embodiment computes, using a change in a level of knowledge corresponding to each node in the network, an amount of knowledge reinforcement to be applied to each node in the network. The embodiment allocates a knowledge reinforcement resource to perform knowledge reinforcement at a subset of the nodes according to a schedule, the subset including the node, the allocated knowledge reinforcement resource to the node having a correspondence with the change in the level of knowledge of the node.

An embodiment includes a computer program product. The computer program product includes one or more computer-readable storage devices, and program instructions stored on at least one of the one or more storage devices.

An embodiment includes a computer system. The computer system includes one or more processors, one or more computer-readable memories, and one or more computer-readable storage devices, and program instructions stored on at least one of the one or more storage devices for execution by at least one of the one or more processors via at least one of the one or more memories.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a block diagram of a network of data processing systems in which illustrative embodiments may be implemented;

FIG. 2 depicts a block diagram of a data processing system in which illustrative embodiments may be implemented;

FIG. 3 depicts a block diagram of an example configuration for reinforcement allocation in socially connected professional networks in accordance with an illustrative embodiment;

FIG. 4 depicts a block diagram of additional operations for reinforcement allocation in socially connected professional networks in accordance with an illustrative embodiment;

FIG. 5 depicts a block diagram of additional operations for reinforcement allocation in socially connected professional networks in accordance with an illustrative embodiment; and

FIG. 6 depicts a flowchart of an example process for reinforcement allocation in socially connected professional networks in accordance with an illustrative embodiment.

### DETAILED DESCRIPTION

The illustrative embodiments recognize that prescription of drugs by a professional depends on the knowledge gained for the professional's peers in the professional's specialized social network in addition to the professional's own knowledge of or familiarity of various drugs. As an example, most drugs are prescribed by general practitioners who don't have as much knowledge as specialists do, and who therefore solicit the opinions of those specialists when making prescribing decisions.

The illustrative embodiments recognize that presently, scheduling a knowledge reinforcement visit to a professional lacks visibility into how the professional uses the reinforced knowledge, whether other professionals benefit from the reinforcement provided to this professional, how much knowledge reinforcement is effective for or needed by this professional, whether and why this professional should be selected for knowledge reinforcement, when the knowledge reinforcement activity should be scheduled for maximizing the activity's effectiveness, or a combination of these and other considerations. Each such consideration operates to reduce the cost of the knowledge reinforcement activity, increase the sales of a drug related to the activity, or both. Lack of visibility into each such consideration works in the opposite direction on the cost, sales, or both.

The illustrative embodiments used to describe the invention generally address and solve the above-described problems and other problems related to identifying how much knowledge reinforcement activity to perform, with which professional(s) to perform them, when to perform them, or a combination thereof.

An embodiment can be implemented as a software application. The application implementing an embodiment can be configured as a modification of an existing scheduling engine and/or order tracking system, as a separate application that operates in conjunction with an existing scheduling engine and/or order tracking system, a standalone application, or some combination thereof.

An embodiment receives, collects, requests, or otherwise obtains, from one or more specialized social media, data related to a set of professionals who participate in such specialized social media. The social media data is used to estimate the current knowledge stock of a professional relative to a previous estimate of the professional's knowledge sock, an amount of knowledge reinforcement needed, a likelihood that the professional will prescribe the drug based on the professional's current sentiment about the drug, or some combination thereof.

According to one embodiment, the professional's sentiment towards the drug is indicative of the likelihood of prescription by the professional. Accordingly, the embodiment parses the obtained data of a professional to determine a sentiment value of the professional towards a drug. Presently available natural language processing (NLP) engines are capable of parsing unstructured data, such as social media data, to determine a sentiment in the data.

An embodiment optionally maps the determined sentiment to a selected range of sentiment values to normalize the sentiment values across professionals, drugs, social media, types of data parsed, or some combination of these and other factors.

An embodiment further uses the sentiment value of the professional towards the drug to compute a likelihood of the professional prescribing the drug in preference to a competing drug. As an example, an industry-specific model can be created in any known manner to map a sentiment value to a likelihood of preferential prescription for the drug. Such mappings can vary from drug to drug, manufacturer to manufacturer, one period of time to another, one professional to another, geographical location of the prescriber, age of the drug, availability of competing drugs in the market, news or other events related to the drug in the marketplace, or a combination of these and many other factors. A model to map the sentiment value to a likelihood of prescription includes logic which quantifies one or more of these and other similar factors, and uses the quantified factors in a mathematical computation which accepts the sentiment value as an input and produces a probability or likelihood as an output.

An embodiment further evaluates the parsed data to determine an amount of knowledge the professional has accumulated about the drug. For example, one embodiment quantifies the amount of data received about the drug by the professional—such as from other professionals, groups, organizations, or entity members of a social network—according to the data of the professional from that social network.

As another example, to determine an amount of knowledge the professional has accumulated about the drug, another embodiment quantifies the amount of data disseminated or provided about the drug by the professional—such as to other professionals, groups, organizations, or entity members of a social network—according to the data of the professional from that social network. Another example embodiment quantifies both the received information as well as the disseminated information to determine an amount of knowledge the professional has accumulated about the drug.

An embodiment uses the amount of knowledge the professional has accumulated about the drug and the likelihood of prescription to determine a knowledge stock of the professional. The knowledge stock, also interchangeably referred to herein as k-stock, of a professional can be regarded as a quantification of the trust the professional places in the drug.

The level of the k-stock of a professional about a drug can fluctuate from period to period. For example, during a period where the professional engages in below a threshold amount of information exchange about the drug on a specialized social media, the k-stock of the professional can deplete. The depletion can be because of forgetting the acquired knowledge about the drug during such a period. As another example, over time, introduction of a competing drug in the market may cause the professional's preference to shift to the competing drug, leading to a depletion of the professional's k-stock about the drug in question. As another example, other market events, such as the publication of an adverse study or case related to the drug, can also cause the preferences to shift and the k-stock to deplete.

The level of the k-stock of a professional about a drug can also increase from period to period. For example, during a period where the professional engages in above a threshold amount of information exchange about the drug on a specialized social media, the k-stock of the professional can increase. The increase can be because of acquiring knowledge about the drug through social network propagation during such a period. The increase can also be because of disseminating or diffusing knowledge about the drug through social network propagation to other professionals during such a period. As another example, over time, an adverse publication about a competing drug in the market may cause the professional's preference to shift to the drug in question, leading to an increase in the k professional's k-stock about the drug. As another example, other market events, such as the publication of a favorable study or case related to the drug, can also cause the preferences to shift favorably and the k-stock to increase.

An embodiment constructs a network of nodes where each node corresponds to a professional. The network of nodes is also interchangeably referred to hereinafter as simply a “network” unless disambiguated expressly where used. The network is constructed based on the data obtained from one or more social media for a past period, and the network remains relevant for a future period. Within this disclosure, where a network is used or described during a period, the period is the period of relevance of the network.

In one embodiment, the network is constructed based on the data obtained from a single specialized social medium. In another embodiment, the network is constructed based on the data obtained from a plurality of specialized social media.

Each node includes a set of parameters. A parameter of the node indicates the k-stock of the corresponding professional during a period, i.e., the period of relevance of the network. Over several periods, the k-stock of a node can fluctuate for the reasons described herein. According to such fluctuations, even if the k-stock of a node is expected to fluctuate up or down within the period of the network, there is a net trend of up or down which is applicable to the k-stock of the node during the period. Another node parameter is configured to indicate the net trend of the k-stock of the node during the period.

Using the trend of the k-stock, an embodiment determines whether knowledge reinforcement activity should be scheduled. For example, an increasing trend in a professional's k-stock is indicative of increasing knowledge of the professional about the drug. In many cases, no additional knowledge reinforcement may be required for the professional over the period of the network. In some cases, if the increasing trend exceeds a threshold rate of increase, no additional knowledge reinforcement may be required for the professional over the period, and if the increasing trend does not exceed the threshold rate of increase, additional knowledge reinforcement may be scheduled for the professional over the period.

Conversely, a decreasing trend in a professional's k-stock is indicative of decreasing knowledge of the professional about the drug. In many cases, additional knowledge reinforcement may be required for the professional over the period. In some cases, if the decreasing trend does not exceed a threshold rate of decrease, no additional knowledge reinforcement may be required for the professional over the period, and if the decreasing trend exceeds the threshold rate of decrease, additional knowledge reinforcement may be scheduled for the professional over the period.

Note that it is possible to adapt an embodiment to not include any k-stock trend information, but use the discrete k-stock value of the node relative to one or more thresholds to make similar determinations as described using the trend information. Such adaptation is contemplated within the scope of the illustrative embodiments.

The amount of knowledge reinforcement activity has a relationship with the trend value (or the k-stock value if trending is not used). The relationship may, but need not be some proportionality. Generally, if the trend up is below a threshold or the trend down is above a threshold, the amount of knowledge reinforcement activity has to increase, and vice-versa.

If knowledge reinforcement activity should be scheduled for a node over the period, an embodiment determines that relationship and computes an amount of such activity, such as a number of knowledge reinforcement visits to the professional, that be scheduled. The embodiment determines the relationship using a variance factor.

The variance factor is a difference between a target sales amount and an actual sales amount of the drug that is projected for the period of the network based on previously observed target and sales data. For example, if the target sales amount for the drug during the period is 100 and the projected sales amount is 20, more knowledge reinforcement activity has to be scheduled as compared to when the target sales amount for the drug during the period is 100 and the projected sales amount is 90.

Thus, the embodiment uses the variance factor to determine a relationship, e.g., proportionality value, with the trend value (or discrete k-stock value), and computes am amount of knowledge reinforcement activity needed for the node during the period of the network. However, as a practical matter, in most pharmaceutical organizations, the budget and resources for conducting the knowledge reinforcement activity is limited for the period. It is possible that the amount of knowledge reinforcement activity needed throughout the network exceeds the budget.

An embodiment makes a selection of a subset of nodes where the knowledge reinforcement activities should be targeted for maximizing the effectiveness of the resources. For example, one embodiment analyzes the past sales data to determine an amount of sales that have been generated from prescriptions from a particular professional. The embodiment further analyzes the sales data to determine a proportion of new prescription sales versus refill sales from a professional. An example rule used by the embodiment can be configured to select those professionals for additional knowledge reinforcement activities who have generated fewer new prescription sales than refill sales. Other rules with other constraints on new prescription sales and refill sales can similarly be configured within the scope of the illustrative embodiments.

As another example, another embodiment analyzes the network to determine a diffusion rate of a node corresponding to a professional. The diffusion rate can be computed as described herein and stored as another node parameter. For example, an amount of social media data in which the professional disseminates the professional's knowledge about the drug can be used to compute a dissemination rate of the professional's knowledge about the drug.

As another example, another embodiment analyzes the network to determine a number of patients a professional corresponding to a node is expected to see during the period. The number of patients expected can be forecasted using past patient visits extracted from the sales data. The patient visits can be stored as another node parameter. For example, if the professional sees below a threshold number of patients, additional knowledge reinforcement activity may not be desirable.

An embodiment uses the new prescriptions sales versus refills proportion, diffusion rate, patient visits, or some combination thereof of a node to select or unselect the node for additional knowledge reinforcement activity. For example, according to one rule, the embodiment selects that node whose new prescription sales exceed a first threshold but do not exceed a second threshold. This example rule excludes those professionals who are generating none or negligible new prescriptions or are generating too many new prescriptions already, either of which case may not warrant additional knowledge reinforcement resources.

According to another example rule, the embodiment selects that node whose diffusion rate exceed a threshold. According to another example rule, the embodiment selects that node whose new prescription sales are below a threshold and whose diffusion rate exceed a threshold. According to another example rule, the embodiment selects that node whose new prescription sales are between two thresholds and whose diffusion rate exceed a threshold.

According to another example rule, the embodiment selects that node whose diffusion rate exceed a threshold and who are expected to see more than a threshold number of patients. According to another example rule, the embodiment selects that node whose new prescription sales are below a threshold and who are expected to see more than a threshold number of patients. According to another example rule, the embodiment selects that node whose new prescription sales are below a threshold, whose diffusion rate exceed a threshold, and who are expected to see more than a threshold number of patients. According to another example rule, the embodiment selects that node whose new prescription sales are between two thresholds, whose diffusion rate exceed a threshold, and who are expected to see more than a threshold number of patients. Many other rules can be constructed in a similar manner and such additional rules are contemplated within the scope of the illustrative embodiments.

Thus the embodiment selects a subset of nodes from the set of nodes in the network, where the nodes in the subset have a need for additional knowledge reinforcement activity, and are expected to deliver a desirable return on investment from the additional knowledge reinforcement activities.

Another embodiment determines a timing aspect of the additional knowledge reinforcement activity for a node in the selected subset of nodes. In many cases, if a node needs three additional knowledge reinforcement visits over a period of four weeks, performing the three knowledge reinforcement visits over days 1, 2, and 3 of week 1 is probably not a very effective way of committing the additional knowledge reinforcement resources. Therefore, the additional knowledge reinforcement activities have to be scheduled at a selected node according to certain considerations.

For example, one rule used by the embodiment for determining the scheduling schedules a knowledge reinforcement visit only if at least a threshold amount of time has elapsed, i.e., a threshold delay has occurred, since a previous knowledge reinforcement visit to the same professional about the same drug. Many other scheduling considerations can be configured as scheduling rules for use by the embodiment in a similar manner and such other rules are contemplated within the scope of the illustrative embodiments.

Even when a subset of nodes has been selected to maximize the return on investment of knowledge reinforcement resource, it may be that not all nodes in the subset deserve the same attention. One embodiment ranks the selected nodes in the subset in an order of preference. The ranking can be based on any combination of factors used to select the subset in the first place. For example, the ranking of a node within the subset can be computed using some combination of the node's new prescription sales amount (stored as a node parameter), diffusion rate (stored as another node parameter), expected number of patient visits (stored as another node parameter).

In one embodiment, the scheduling of the additional knowledge reinforcement activity is also dependent on the ranking of the node for which the activity is being scheduled. For example, a higher ranking node may be preferentially scheduled relative to a lower ranking node, such as during days or hours preferred by professionals for such visits. As another example, if excess budget is available, a higher ranking node may be scheduled to receive additional knowledge reinforcement visit from the excess budget as opposed to a lower ranking node.

The subset of nodes, the ranking within the subset, and the allocations of knowledge reinforcement resources to a selected node can change from period to period. The change can be based on the improvements seen from a previous iteration of additional knowledge reinforcement activities, changes in the budget, and many other factors. An illustrative embodiment constructs the network for each period and performs some or all of the operations described herein to allocate the knowledge reinforcement resources within the network.

A method of an embodiment described herein, when implemented to execute on a device or data processing system, comprises substantial advancement of the functionality of that device or data processing system towards performing knowledge reinforcement activities in a cost-effective manner. For example, presently available methods for providing knowledge reinforcement to professionals wastes knowledge reinforcement resources by visiting the wrong professionals, over or under-providing the knowledge reinforcement, providing the knowledge reinforcement at an undesirable frequency, generating sub-optimal return on investment of knowledge reinforcement resources, or some combination thereof. An embodiment provides a method by which the k-stock of a professional is monitored for the effectiveness of knowledge reinforcement activities. An embodiment delivers additional knowledge reinforcement according to the performance of the professional with patients, on the specialized social media, and relative to other professionals. This manner of reinforcement allocation in socially connected professional networks is unavailable in the presently available methods. Thus, a substantial advancement of such devices or data processing systems by executing a method of an embodiment is in distributing the knowledge reinforcement resources more efficiently within the network of professionals and improving the benefit derived from such distributing.

The illustrative embodiments are described with respect to certain types of professionals, social media, computations, algorithms, trends, rules, variance, evaluations, rankings, budgeting, scheduling, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

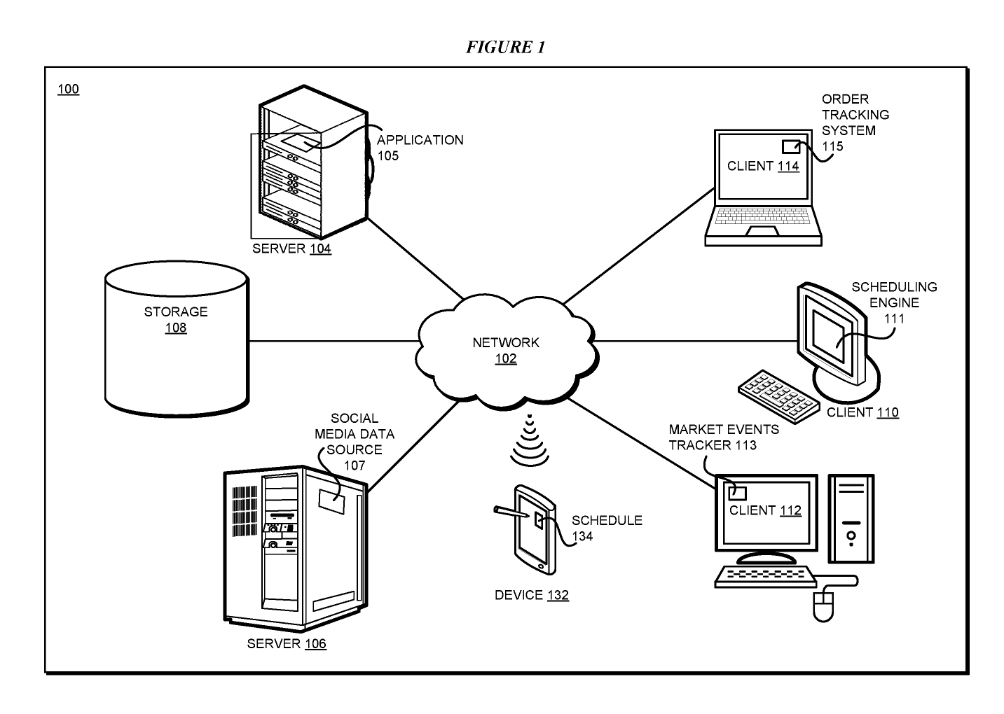

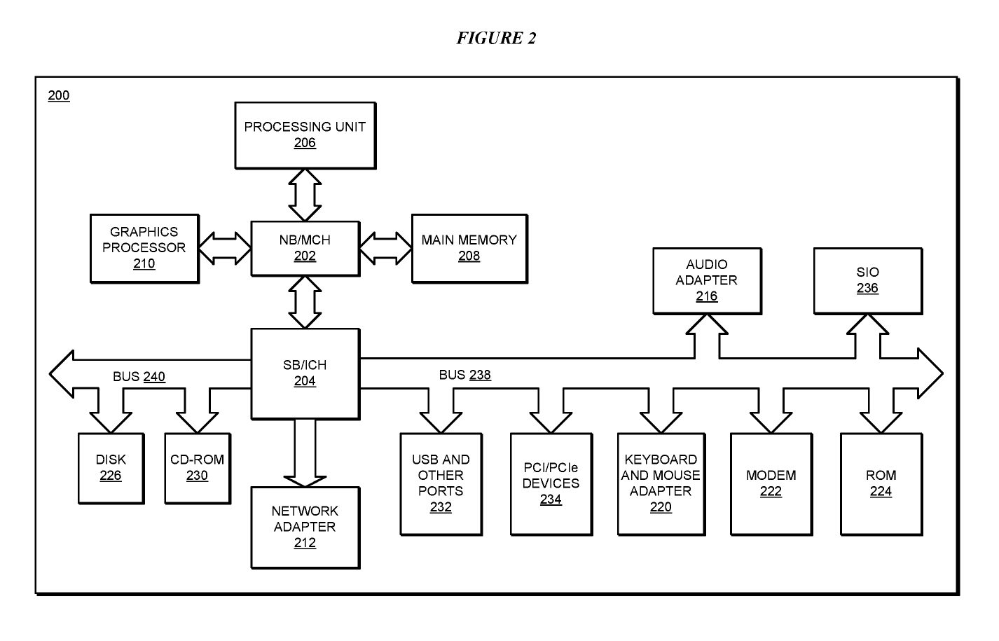

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables.

Clients or servers are only example roles of certain data processing systems connected to network 102 and are not intended to exclude other configurations or roles for these data processing systems. Server 104 and server 106 couple to network 102 along with storage unit 108. Software applications may execute on any computer in data processing environment 100. Clients 110, 112, and 114 are also coupled to network 102. A data processing system, such as server 104 or 106, or client 110, 112, or 114 may contain data and may have software applications or software tools executing thereon.

Only as an example, and without implying any limitation to such architecture, FIG. 1 depicts certain components that are usable in an example implementation of an embodiment. For example, servers 104 and 106, and clients 110, 112, 114, are depicted as servers and clients only as example and not to imply a limitation to a client-server architecture. As another example, an embodiment can be distributed across several data processing systems and a data network as shown, whereas another embodiment can be implemented on a single data processing system within the scope of the illustrative embodiments. Data processing systems 104, 106, 110, 112, and 114 also represent example nodes in a cluster, partitions, and other configurations suitable for implementing an embodiment.

Device 132 is an example of a device described herein. For example, device 132 can take the form of a smartphone, a tablet computer, a laptop computer, client 110 in a stationary or a portable form, a wearable computing device, or any other suitable device. Any software application described as executing in another data processing system in FIG. 1 can be configured to execute in device 132 in a similar manner. Any data or information stored or produced in another data processing system in FIG. 1 can be configured to be stored or produced in device 132 in a similar manner.

Application 105 implements an embodiment described herein. Social media data source 107 is a data source associated with a specialized social media for medical professionals and pharmaceutical industry-related entities. Scheduling engine 111 produces knowledge reinforcement activity schedules for sales representatives, such as schedule 134 on a sales representative's device 132. Market events tracker 113 tracks events occurring in the marketplace related to the pharmaceutical drug in question, to help analyze sentiment shocks—sudden changes, or changes of more than a threshold amount over a threshold period, in a professional's sentiment towards the drug—in the social media data. order tracking system 115 provides the sales data using which application 105 determines the variance as described herein.

Servers 104 and 106, storage unit 108, and clients 110, 112, and 114 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications.

With reference to FIG. 2, this figure depicts a block diagram of a data processing system in which illustrative embodiments may be implemented. Data processing system 200 is an example of a computer, such as servers 104 and 106, or clients 110, 112, and 114 in FIG. 1, or another type of device in which computer usable program code or instructions implementing the processes may be located for the illustrative embodiments.

Data processing system 200 is also representative of a data processing system or a configuration therein, such as data processing system 132 in FIG. 1 in which computer usable program code or instructions implementing the processes of the illustrative embodiments may be located. Data processing system 200 is described as a computer only as an example, without being limited thereto. Implementations in the form of other devices, such as device 132 in FIG. 1, may modify data processing system 200, such as by adding a touch interface, and even eliminate certain depicted components from data processing system 200 without departing from the general description of the operations and functions of data processing system 200 described herein.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and I/O controller hub 204 through bus 238. Hard disk drive (HDD) or solid-state drive (SSD) 226 and CD-ROM 230 are coupled to South Bridge and I/O controller hub 204 through bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. Hard disk drive or solid state drive 226, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system such as AIX® (AIX is a trademark of International Business Machines Corporation in the United States and other countries), Microsoft® Windows® (Microsoft and Windows are trademarks of Microsoft Corporation in the United States and other countries), Linux® (Linux is a trademark of Linus Torvalds in the United States and other countries), iOS™ (iOS is a trademark of Cisco Systems, Inc. licensed to Apple Inc. in the United States and in other countries), or Android™ (Android is a trademark of Google Inc., in the United States and in other countries). An object oriented programming system, such as the Java™ programming system, may run in conjunction with the operating system and provide calls to the operating system from Java™ programs or applications executing on data processing system 200 (Java and all Java-based trademarks and logos are trademarks or registered trademarks of Oracle Corporation and/or its affiliates).

Instructions for the operating system, the object-oriented programming system, and applications or programs, such as application 105 in FIG. 1, are located on storage devices, such as hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a mobile or wearable device.

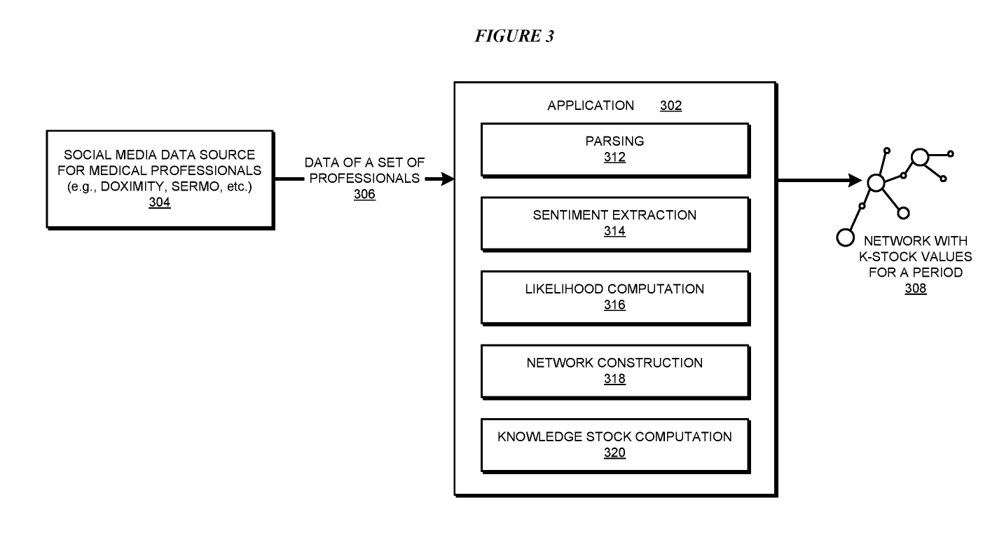

With reference to FIG. 3, this figure depicts a block diagram of an example configuration for reinforcement allocation in socially connected professional networks in accordance with an illustrative embodiment. Application 302 is an example of application 105 in FIG. 1. Data source 304 is an example of data source 107 in FIG. 1. Only one data source 304 is depicted and described for clarity and not to imply any limitation. Any number of data sources similar to data source 304 can be used in an implementation without departing the scope of the illustrative embodiments.

Data source 304 provides data 306 about a set of professionals. Component 312 of application 302 parses data 306. Component 314 performs sentiment extraction from the parsed data, such as by using an NLP engine (not shown). The sentiment value produced by component 314 pertains to a particular pharmaceutical drug. The sentiment value is expected to remain valid for a future period—the period of network 308.

Component 316 computes a likelihood of prescribing the drug for one or more professionals in the set of professionals. Component 316 constructs network 308. For the period of network 308, component 318 computes the k-stock value of each node in network 308 and populates a corresponding node parameter with the computed k-stock value.

In one embodiment, a visual representation of a network node in network 308 is related to the node's k-stock value. For example, in a visual display of network 308, a size of node may be depicted as proportional to the node's k-stock value. In another embodiment, a color of the node is selected according to the node's k-stock value.

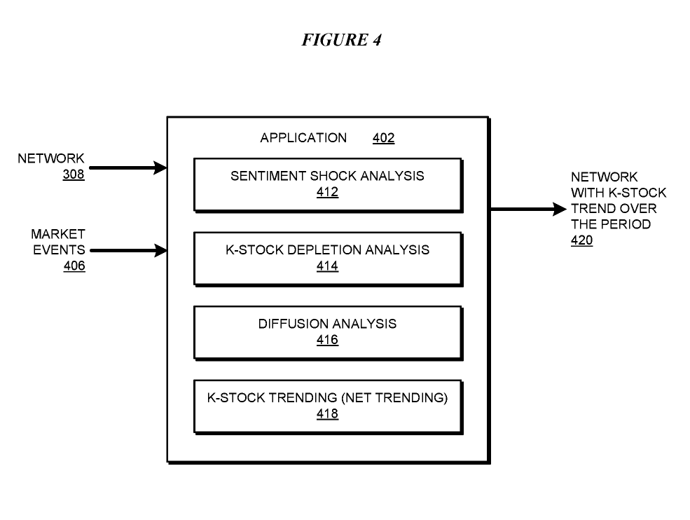

With reference to FIG. 4, this figure depicts a block diagram of additional operations for reinforcement allocation in socially connected professional networks in accordance with an illustrative embodiment. Application 402 is an example of application 302 in FIG. 3, enhanced with the operations described relative to FIG. 4. Network 308 is as produced in FIG. 3.

Component 412 uses market events 406, as produced by market events tracker 113 in FIG. 1, to perform sentiment shock analysis on the parsed data produced by component 312 in FIG. 3. The sentiment shock analysis provides information usable in determining a reason for the k-stock trend of a node. Some market events driven sentiment shocks are correctable by additional knowledge reinforcement activity, others are not. The determined reason for the sentiment shock allows an embodiment to decide whether to regard a trend change (or discrete k-stock value change) of a node as warranting additional knowledge reinforcement activity. The determinations of component 412 can be stored as one or more node parameters.

Component 414 performs depletion analysis of the k-stock of the nodes of network 308. Component 414 determines whether the k-stock of a node has depleted, by how much it has depleted, and whether the depletion is a result of a sentiment shock. The determinations of component 414 can be stored as one or more node parameters.

Component 416 performs diffusion analysis of the nodes in network 308. Component 416 determines a level of diffusion of knowledge provided by the professional associated with a node. The determinations of component 416 can be stored as one or more node parameters.

Component 418 produces a net trend value for the k-stock of a node for the period of network 308. The determinations of component 416 can be stored as one or more node parameters.

Application 402 outputs or produces network 420 which includes nodes with k-stock trend value. The outputs of component 412, 414, and 416 are used for knowledge reinforcement resource allocation as described herein.

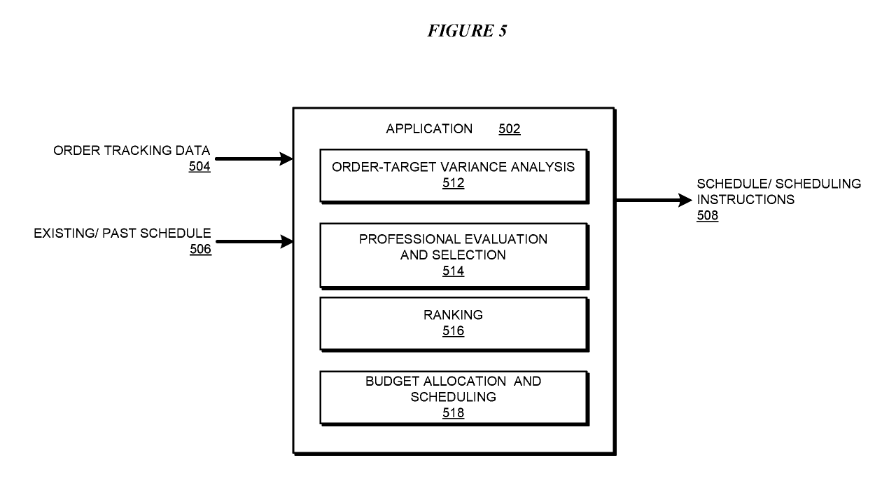

With reference to FIG. 5, this figure depicts a block diagram of additional operations for reinforcement allocation in socially connected professional networks in accordance with an illustrative embodiment. Application 502 is an example of application 402 in FIG. 4, enhanced with the operations described relative to FIG. 5.

Component 512 uses order tracking data 504, as produced by order tracking system 115 in FIG. 1, to perform order-target variance analysis. The variance determines a difference between actual sales and target sales values of the drug over one or more past periods.

Component 514 performs professional evaluation and selection using network 308 of FIG. 3 or network 420 of FIG. 4. Particularly, component 514 selects from the network a subset of nodes as described herein. For example, component 514 uses the outputs of components 412, 414, 416, 418, the proportion of new prescriptions versus refills for a node according to order tracking data 504, number of patient visits expected for the node according to order tracking data 504, or some combination thereof, to make the selections.

Component 516 ranks the subset of nodes as described elsewhere in this disclosure. For example, using order tracking data 504, component 516 determines the proportion of new prescriptions versus refills for a node, number of patient visits expected for the node, or both. Component 516 uses proportion of new prescriptions versus refills for a node, number of patient visits expected for the node, output of diffusion analysis component 416, output of trending component 418, or some combination thereof to determine a rank of the node.

Component 518 determines the budget allocation for, and produces the scheduling of the additional knowledge reinforcement activities. Component 518 produces as output 508 a schedule of the additional knowledge reinforcement activities, or instructions for scheduling engine 111 of FIG. 1 to produce the schedule.

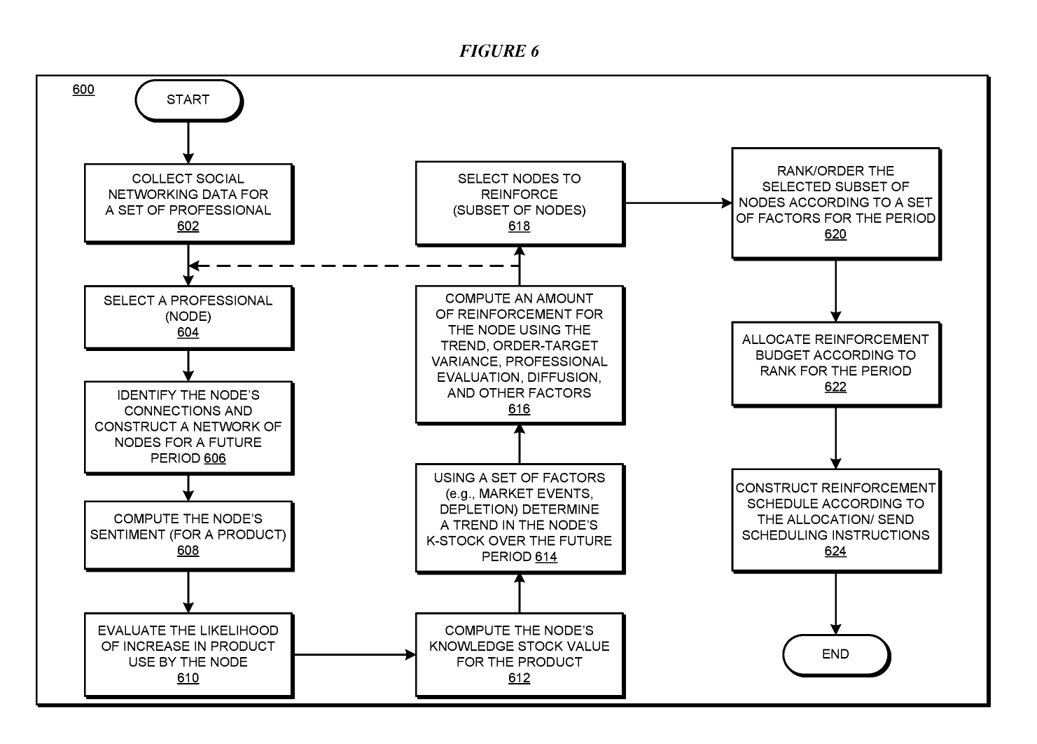

With reference to FIG. 6, this figure depicts a flowchart of an example process for reinforcement allocation in socially connected professional networks in accordance with an illustrative embodiment. Process 600 can be implemented in application 502 of FIG. 5.

The application collects social networking data for a set of professionals from a specialized social network (block 602). The application selects a professional (block 604). The professional represents a node.

The application identifies the node's connections in the specialized social network and constructs the network of nodes for a future period (block 606). The application computes a sentiment value corresponding to the node (block 608). The sentiment value is computed from the data of block 602, for a specific product, e.g., a particular pharmaceutical drug.

The application evaluates the likelihood of an increase in the use of the product triggered by the node (block 610). In other words, the application computes how likely the professional corresponding to the node is to prescribe the product.

The application computes the node's k-stock value for the product (block 612). The application, using a set of factors, determines or forecasts a trend in the node's k-stock over the future period (block 614). The application computes an amount of knowledge reinforcement needed for the node (block 616). The computation of block 616 uses the trend, order-target variance, professional evaluation from the data of block 602 and order tracking data, diffusion value, or a combination of these and other factors as described herein. The application repeats blocks 604-616 for some or all professionals in the set of professionals.

The application selects a subset of nodes for knowledge reinforcement (block 618). The application ranks the nodes in the selected subset for eth future period according to the k-stock value, trend, number of patient visits expected, and/or other factors described herein (block 620).

The application allocates knowledge reinforcement budget according to the ranking for the future period (block 622). The application constructs a knowledge reinforcement schedule according to the allocation, or sends instructions to a scheduling engine for producing such a schedule (block 624). The application ends process 600 thereafter.

Thus, a computer implemented method, system or apparatus, and computer program product are provided in the illustrative embodiments for reinforcement allocation in socially connected professional networks and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method comprising:
constructing, from data obtained from a data source of a social medium, a network including a node, the node corresponding to a medical professional, and the network including a plurality of other nodes corresponding to other participants connected with the medical professional in the social medium;
determining, from the data, a likelihood of the node prescribing a product;
computing, using a processor and a memory, from the data, for a period, a level of knowledge of the node about the product;
determining a change in the level of knowledge of the node from a previous period;
computing, using a change in a level of knowledge corresponding to each node in the network, an amount of knowledge reinforcement to be applied to each node in the network; and
allocating a knowledge reinforcement resource to perform knowledge reinforcement at a subset of the nodes according to a schedule, the subset including the node, the allocated knowledge reinforcement resource to the node having a correspondence with the change in the level of knowledge of the node.

2. The method of claim 1, further comprising:
selecting the subset of nodes from the nodes of the network, wherein a node in the network is selected into the subset when a proportion of new prescription of the product by the node to refills of the product by the node is between two threshold proportions.

3. The method of claim 1, further comprising:
selecting the subset of nodes from the nodes of the network, wherein a node in the network is selected into the subset when an expected number of patient visits during the period for the node exceeds a threshold number of visits.

4. The method of claim 1, further comprising:
selecting the subset of nodes from the nodes of the network, wherein a node in the network is selected into the subset when a diffusion value for the node exceeds a threshold diffusion value.

5. The method of claim 1, further comprising:
determining, from the data, an amount of information disseminated over the social medium by the node about the product; translating the amount of information disseminated into the level of knowledge associated with the node.

6. The method of claim 5, further comprising:
computing, from the amount of information disseminated, a diffusion value for the node.

7. The method of claim 1, further comprising:
ranking the nodes within the subset of nodes, wherein the allocated knowledge reinforcement resource to the node has a correspondence with the ranking of the node.

8. The method of claim 7, further comprising:
computing the ranking using at least one of (i) a proportion of new prescription of the product by the node to refills of the product by the node, (ii) an expected number of patient visits during the period for the node, and (iii) a diffusion value for the node.

9. The method of claim 1, further comprising:
determining a gap amount between an actual sales amount of the product and a target sales amount of the product for the previous period; and
further using the gap amount in computing the change in each level of knowledge corresponding to each node in the network.

10. The method of claim 1, wherein the change in the level of knowledge is caused by depletion resulting from less than a threshold amount of information exchange about the drug by the node during the previous period.

11. The method of claim 1, wherein the change in the level of knowledge is caused by market event resulting from an adverse publication about the drug during the previous period.

12. The method of claim 1, further comprising:
computing, for the level of knowledge, a net trend over the period, the net trend being an overall direction of change in the level of knowledge during the period.

13. The method of claim 1, further comprising:
determining, from the data, an amount of information acquired over the social medium by the node about the product; and
translating the amount of information acquired into the level of knowledge associated with the node.

14. The method of claim 1, wherein the social media is specialized for use by medical professionals and pharmaceutical entities, further comprising:
parsing the data to extract a sentiment value of the node for the product, wherein the likelihood is determined from the sentiment value.

15. The method of claim 1, wherein the method is embodied in a computer program product comprising one or more computer-readable storage devices and computer-readable program instructions which are stored on the one or more computer-readable tangible storage devices and executed by one or more processors.

16. The method of claim 1, wherein the method is embodied in a computer system comprising one or more processors, one or more computer-readable memories, one or more computer-readable storage devices and program instructions which are stored on the one or more computer-readable storage devices for execution by the one or more processors via the one or more memories and executed by the one or more processors.

17. A computer program product comprising one or more computer-readable storage devices, and program instructions stored on at least one of the one or more storage devices, the stored program instructions comprising:
program instructions to construct, from data obtained from a data source of a social medium, a network including a node, the node corresponding to a medical professional, and the network including a plurality of other nodes corresponding to other participants connected with the medical professional in the social medium;
program instructions to determine, from the data, a likelihood of the node prescribing a product;
program instructions to compute, using a processor and a memory, from the data, for a period, a level of knowledge of the node about the product;
program instructions to determine a change in the level of knowledge of the node from a previous period;
program instructions to compute, using a change in a level of knowledge corresponding to each node in the network, an amount of knowledge reinforcement to be applied to each node in the network; and
program instructions to allocate a knowledge reinforcement resource to perform knowledge reinforcement at a subset of the nodes according to a schedule, the subset including the node, the allocated knowledge reinforcement resource to the node having a correspondence with the change in the level of knowledge of the node.

18. The computer program product of claim 17, further comprising:
program instructions to select the subset of nodes from the nodes of the network, wherein a node in the network is selected into the subset when a proportion of new prescription of the product by the node to refills of the product by the node is between two threshold proportions.

19. The computer program product of claim 17, further comprising:
program instructions to select the subset of nodes from the nodes of the network, wherein a node in the network is selected into the subset when an expected number of patient visits during the period for the node exceeds a threshold number of visits.

20. A computer system comprising one or more processors, one or more computer-readable memories, and one or more computer-readable storage devices, and program instructions stored on at least one of the one or more storage devices for execution by at least one of the one or more processors via at least one of the one or more memories, the stored program instructions comprising:
program instructions to construct, from data obtained from a data source of a social medium, a network including a node, the node corresponding to a medical professional, and the network including a plurality of other nodes corresponding to other participants connected with the medical professional in the social medium;
program instructions to determine, from the data, a likelihood of the node prescribing a product;
program instructions to compute, using a processor and a memory, from the data, for a period, a level of knowledge of the node about the product;
program instructions to determine a change in the level of knowledge of the node from a previous period;
program instructions to compute, using a change in a level of knowledge corresponding to each node in the network, an amount of knowledge reinforcement to be applied to each node in the network; and
program instructions to allocate a knowledge reinforcement resource to perform knowledge reinforcement at a subset of the nodes according to a schedule, the subset including the node, the allocated knowledge reinforcement resource to the node having a correspondence with the change in the level of knowledge of the node.
